(19) United States
(12) Patent Application Publication
(10) Pub. No.: US 2024/0156164 A1
(43) Pub. Date: May 16, 2024

(54) Heater For Consumable Comprising Solid Aerosol Generating Substrate

(71) Applicant: JT International SA, Geneva (CH)

(72) Inventors: Alec Wright, Guildford (GB); Andrew Robert John Rogan, Forres (GB)

(73) Assignee: JT International SA, Geneva (CH)

(21) Appl. No.: 18/279,923

(22) PCT Filed: Mar. 4, 2022
(86) PCT No.: PCT/EP2022/055634

§ 371 Date: Sep. 1, 2023

(30) Foreign Application Priority Data
Mar. 5, 2021 (EP) 21161089.4

(51) Int. Cl. A24F 40/46; A24F 40/20; A24F 40/42; H05B 3/16

(52) U.S. Cl. CPC A24F 40/46; A24F 40/20; A24F 40/42; H05B 3/16; H05B 2203/003

(57) ABSTRACT

A heater for heating a consumable including a solid aerosol generating substrate includes a base; and a heating element attached to a support surface of the base, wherein the heating element includes a moulding surface configured to deform and heat the aerosol generating substrate. An aerosol generation device includes a substrate storage chamber configured to receive a consumable including a solid aerosol generating substrate, the substrate storage chamber including the aforementioned heater arranged on a surface of the substrate storage chamber with the support surface facing into the substrate storage chamber.

### TECHNICAL FIELD

The present disclosure relates to heaters for aerosol generating devices. In particular, the application relates to heaters configured to heat a solid aerosol generating substrate to generate an aerosol. Such devices may heat, rather than burn, tobacco or other suitable aerosol generating substrate materials by conduction, convection, and/or radiation, to generate an aerosol for inhalation.

### BACKGROUND

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generating device or heat-not-burn device. Devices of this type generate an aerosol or vapour by heating an aerosol generating substrate that typically comprises moist leaf tobacco or other suitable aerosolisable material to a temperature typically in the range 150° C. to 350° C. Heating an aerosol generating substrate, but not combusting or burning it, releases an aerosol that comprises the components sought by the user but not the toxic and carcinogenic by-products of combustion and burning. Furthermore, the aerosol produced by heating the tobacco or other aerosolisable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

In such devices it is desirable to improve heating speed and efficiency. It is therefore desirable to provide alternative configurations for a heater which can improve one or more of heating speed and heating efficiency, or which can be controlled to improve heating speed or heating efficiency.

In a previous application EP20176125.1 by the applicant, the above problems were addressed with a layered heating structure in which heat is conducted from a conductive track, through an electrical insulation layer, and then through a heat conduction layer (such as a layer of stainless steel) to supply heat at a heating surface on an opposite side of the heating layer. With this arrangement, the conductive track is protected away from the heating surface, and the heating surface can be easily cleaned. However, the heating speed and efficiency could still be further improved.

### SUMMARY

According to a first aspect, the present disclosure provides a heater for heating a consumable comprising a solid aerosol generating substrate, the heater comprising: a base; and a heating element attached to a support surface of the base, wherein the heating element comprises a moulding surface configured to deform and heat the aerosol generating substrate.

With this configuration, the heating element reaches closer to a centre of the aerosol generating substrate and can thus more efficiently deliver heat throughout the aerosol generating substrate.

Optionally, the heating element comprises a thick conductive track extending along and protruding from the support surface. With this configuration, the site of heat generation is placed as close as possible to the aerosol generating substrate, to further improve heating efficiency.

Optionally, the heater comprises a substrate protruding from the base to form a moulding shape or blade shape, and a conductive track on the substrate. With this configuration, the moulding surface can be provided without increasing a thickness of the heating element.

Optionally, the substrate is an extension of the base.

Optionally, the conductive track has a serpentine configuration. This configuration increases the resistance of the conductive track in a given area of the support surface.

Optionally, the heating element protrudes from the support surface by a protrusion distance of at least 0.5 mm.

Optionally, the base comprises a porous ceramic material, and at least part of the support surface is exposed to receive a vapour or aerosol generated from the aerosol generating substrate. This configuration provides additional volume for vapour/aerosol formation adjacent to the aerosol generating substrate.

According to a second aspect, the present disclosure provides an aerosol generation device comprising a substrate storage chamber configured to receive a consumable comprising a solid aerosol generating substrate, the substrate storage chamber comprising a heater according to the first aspect arranged on a surface of the heating chamber with the support surface facing into the substrate storage chamber.

Optionally, the aerosol generation device further comprises an air flow channel for drawing air through the aerosol generation device, wherein the heater is arranged between the substrate storage chamber and the air flow channel. This configuration provides a physical barrier between the substrate and the air flow channel, ensuring that the substrate does not enter the air flow channel and simplifying maintenance of the air flow channel.

Optionally, the heating element extends substantially across the whole of the surface of the substrate storage chamber.

Optionally, the aerosol generation device further comprises a compression element configured to compress the consumable against the heater.

Compressing the substrate improves efficiency of heating and vapour/aerosol generation.

According to a third aspect, the present disclosure provides an aerosol generation system comprising a heater according to first aspect and a consumable, wherein the heating element protrudes from the surface of the ceramic base by at least 5% of a thickness of the consumable.

### BRIEF DESCRIPTION OF THE DRAWINGS

FIG. 1 is a perspective schematic illustration of a heater;

FIG. 2A is a schematic cross-section illustration of the heater;

FIG. 2B is a schematic cross-section illustration of the heater arranged in use to deliver heat to an aerosol generating substrate;

FIG. 3 is a schematic cross-section illustration of an alternative heater;

FIGS. 4A, 4B and 4C are schematic cross-sections of an example of an aerosol generating device incorporating the heater of FIG. 2A or 3;

FIG. 5 is a schematic illustration of a specific example of the aerosol generating device;

FIG. 6 is a schematic illustration of a second specific example of the aerosol generating device;

FIGS. 7A, 7B and 7C are schematic cross-sections of an alternative example of an aerosol generating device incorporating the heater of FIG. 2A or 3.

### DETAILED DESCRIPTION

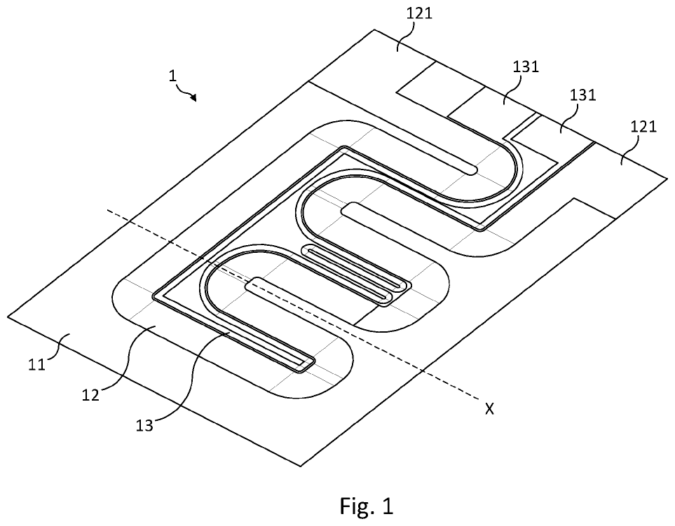

FIG. 1 is a perspective schematic illustration of a heater 1.

The heater comprises a base 11, and a heating element 12 attached to a support surface of the base 11. Specifically, in this example the heating element 12 is a first electrically conductive track.

The first electrically conductive track 12 is operable to generate heat by resistive heating when a current is passed along the track. The first electrically conductive track 12 may, for example, have a serpentine configuration in order to increase the length and resistance of the track. At each end 121 of the first electrically conductive track 12, there is an electrical connector for attaching a power source to the first electrically conductive track 12. In this embodiment, the electrical connector is a soldering pad, although any other type of electrical connector may be used.

The heater 1 also optionally comprises a second electrically conductive track 13 attached to the support surface of the base 11. The second electrically conductive track 13 is used to sense a temperature based on a resistance-temperature characteristic of the second electrically conductive track 13. In other words, by measuring a resistance value of the second track 13 and converting the resistance value to a temperature value using the resistance-temperature characteristic, a temperature is indirectly sensed by the second electrically conductive track 13. The resistance-temperature characteristic may be measured specifically for the second electrically conductive track 13, or may be calculated based on the materials and dimensions of the second electrically conductive track 13. At each end 131 of the second electrically conductive track 13, there is an electrical connector for attaching a power source to the second electrically conductive track 13. In this embodiment, the electrical connector is a soldering pad, although any other type of electrical connector may be used.

The heating element 12 and the second electrically conductive track 13 may each be formed from an electrically conductive material such as copper or graphite. More preferably, the heating element 12 (and optionally also the second electrically conductive track 13) is formed from an inert material such as gold or platinum, which will not oxidise when heated.

The second electrically conductive track 13 is configured to have a higher electrical resistance than the heating element 12 at a given temperature (e.g. room temperature, 20° C.). The higher resistance increases the sensitivity of the second track 13 to temperature variation, whereas the lower resistance of the heating element 12 increases the current draw and the heating speed of the heating element 12. The difference in resistance may be provided by using different materials. For example, the heating element 12 may comprise copper while the second electrically conductive track 13 comprises platinum, stainless steel or an electrically-conductive ceramic. Platinum in particular has the advantage that its resistance varies with temperature in a highly linear manner. Additionally or alternatively, the difference in resistance may be provided by using different dimensions for the tracks. For example, as shown in FIG. 1, the second electrically conductive track 13 is longer and narrower than the first electrically conductive track 12.

In some embodiments, rather than having two electrically conductive tracks that are specialised for the separate functions of heating and temperature sensing, a single electrically conductive track may perform both functions. In other words, the second electrically conductive track 13 may be omitted, and a temperature may be sensed by measuring a resistance of the first electrically conductive track 12 and by using a resistance-temperature characteristic of the first electrically conductive track 12. Furthermore, a separate temperature sensor, not forming part of the structure of FIG. 1, may be used.

Additionally, in some embodiments, two or more heating elements (e.g. electrically conductive tracks) may be independently configured for generating heat, allowing for a variable total heating rate by changing a number of heating elements which receive a power supply.

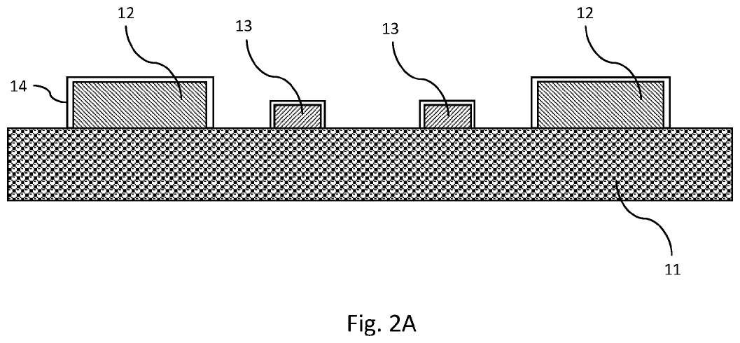

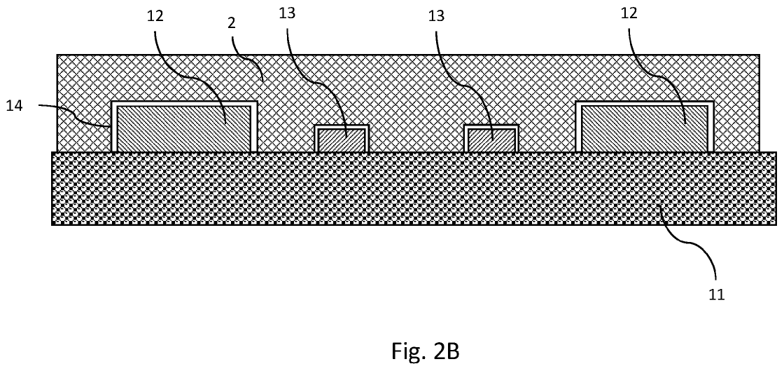

FIG. 2A is a schematic cross-section illustration of the heater 1 along the dashed line X marked in FIG. 1. FIG. 2B is a schematic cross-section illustration of the heater 1 arranged in use to deliver heat to an aerosol generating substrate 2.

The heating element 12 is operable to emit heat in use as shown in FIG. 2B, in order to deliver heat to the aerosol generating substrate 2.

As the aerosol generating substrate 2 is heated, vapour forms which subsequently cools to form an aerosol.

The base 11 preferably comprises a porous material, such as a porous ceramic, and at least part of the support surface on which the heating element 12 is located is exposed to receive vapour or aerosol. A porous ceramic has pores through which vapour or aerosol may travel and thus the porous base can receive vapour or aerosol generated from the aerosol generating substrate 2, providing additional space for vapour to form and cool into aerosol particles. Additionally, the porous ceramic can transport vapour or aerosol away from the aerosol generating substrate 2 and towards a site at which, for example, a user may inhale the aerosol. On the other hand, using a ceramic material has the advantage of high heat tolerance, meaning that the a porous ceramic can assist with vapour/aerosol generation without being damaged near to the heating element 12. For example, the porous ceramic may be similar to the liquid conducting body described in EP 3526972 A1.

Alternatively, in some embodiments, the base 11 need not be porous, and may instead comprise a stainless steel such as steel grade 1.4404 (316L) or 1.4301 (304). In such embodiments, electrical insulation may be located between the heating element 12 and the base 11.

As shown in FIG. 2A, the heating element 12 may comprise a thick conductive track that protrudes from the support surface of the base 11, in addition to extending along the support surface as shown in FIG. 1. A thick conductive track of this kind forms a moulding surface which will deform a solid aerosol generating substrate, and thus reach closer to a centre of the substrate and deliver heat more efficiently to the substrate. In order to avoid lowering the resistance of the resistive track, the thick conductive track may be configured as a thin blade protrusion from the support surface.

As further shown in FIG. 2A, a protective layer 14 is provided to cover the heating element 12 and the second electrically conductive track 13. The protective layer 14 is configured to protect the heating element 12 and the second electrically conductive track 13 from oxidizing when they becomes hot in use. Furthermore, a material for the protective layer 14 may be selected to be an electrical insulator in order to enable more dense packing of a winding route in the first and second electrically conductive tracks 12, 13 without risk of short-circuit. The protective layer 14 may, for example, comprise silica, a polyimide, alumina, or a photoresist material. The protective layer 14 may have a thickness of, for example, 1-2 nm.

However, the protective layer 14 is preferably omitted in order to maximise thermal contact between the heating element 12 and the aerosol generating substrate 2. This can be achieved if the heating element 12 is formed from an inert material that will not oxidise when hot.

In order to improve the correspondence between a temperature sensed by the second electrically conductive track 13 and a temperature caused by heat generation at the heating element 12, the second electrically conductive tracks is preferably arranged nearby to the heating element 12.

Correspondence between a temperature sensed by the second electrically conductive track 13 and a temperature caused by heat generation at the first electrically conductive track 12 is to arrange the first electrically conductive track 12 to surround the second electrically conductive track 13. Referring again to FIG. 1, the first electrically conductive track 12 forms an open loop between two electrical contacts at its ends 121, which are arranged at a side of the heater assembly 1. The second electrically conductive track 13 is confined between the first electrically conductive track 12 and the side of the layered heater assembly where the contacts 121 are located, meaning that the second electrically conductive track 13 is substantially surrounded by the first electrically conductive track 12.

Advantageously, the second electrically conductive track 13 may similarly form an open loop between its two ends 131, and electrical contacts for both tracks may be arranged along a single side of the heater.

Turning to FIG. 2B, the heater 1 is oriented for a use case where an aerosol generating substrate 2 rests on the heating element 12 and on the support surface of the base 11 of the heater 1.

The aerosol generating substrate 2 is a solid substrate which may for example comprise nicotine or tobacco and an aerosol former. Here the term solid includes soft materials and loose materials, and used primarily to distinguish from liquid aerosol generating substrates 2. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

The thick conductive track of a heating element 11 may protrude from the support surface by a protrusion distance of at least 5% of a thickness D of the consumable. In absolute terms, the protrusions distance is preferably at least around 0.5 mm, and more preferably at least around 0.75 mm.

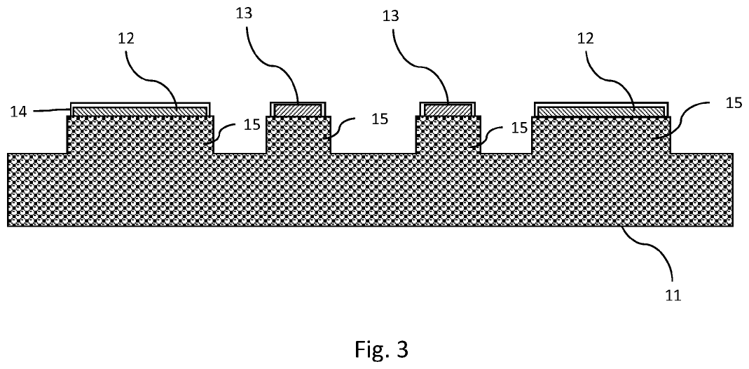

FIG. 3 is a schematic cross-section illustration of an alternative heater 1 along the dashed line X marked in FIG. 1.

In the alternative heater 1 of FIG. 3, the heater 1 additionally comprises an extension 15 protruding from the base 11 to form one or more moulding shapes or blade shapes that are configured to deform the aerosol generating substrate 2.

In the alternative heater 1 of FIG. 3, the heating element 12 need not be thick, and the moulding surface of the heating element 12 can simply comprise a planar heating element 12 laid on top of the extension 15. For example, the extension 15 may protrude from the base 11 by a protrusion distance of at least around 0.5 mm, and more preferably protrude by at least around 0.75 mm. On the other hand, the heating element 12 may be a thin electrically conductive track with a thickness of as little as the order of 100 nm to 1 μm. In one specific example, the first electrically conductive track 12 has a thickness of 500 nm and the second electrically conductive track 13 has a thickness of 300 nm.

Preferably, the extension 15 is a monolithic part of the base 11. In the case where the base 11 is porous, the extension 15 thus provides additional surface area for vapour/aerosol to travel out of the aerosol generating substrate 2 when the heating element 11 heats the aerosol generating substrate 2.

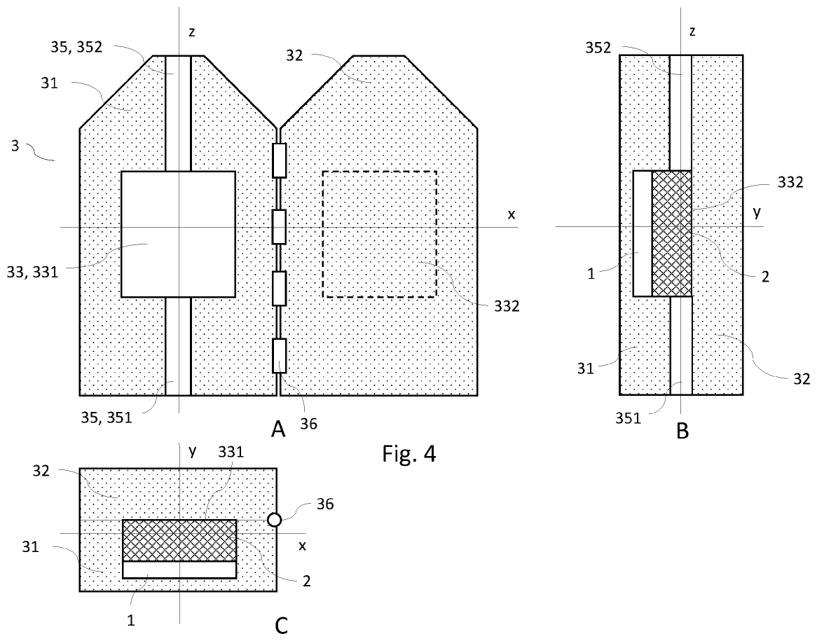

FIGS. 4A, 4B and 4C are schematic cross-sections of an example of an aerosol generating device 3 incorporating a heater assembly 1 as described above with reference to FIG. 2A or 3, with lines x, y and z showing the relative planes of the cross-sections.

The aerosol generating device 3 comprises a first housing element 31 and a second housing element 32. When the aerosol generating device 3 is in a closed position as shown in FIGS. 4B and 4C, the first housing element 31 and the second housing element 32 together define a substrate storage chamber 33 in which a portion 2 of aerosol generating substrate aerosol is enclosed, and aerosol is generated from the portion 2 of aerosol generating substrate.

The first housing element 31 comprises a recess 33 (receiving means) for receiving the portion 2 of aerosol generating substrate, and the second housing element 32 comprises a lid surface 332 arranged to oppose a flat bottom surface 331 of the recess. The recess 33 may be substantially cuboid with a length L and width W in the plane of FIG. 4A, and a depth d. The portion 2 of aerosol generating substrate may correspondingly have a length L and width W, but may have a depth D.

Additionally, when the aerosol generating device 3 is in the closed position, the lid surface 332 is arranged to oppose the bottom surface 331 of the recess 33, and in a case where the depth D of the portion 2 is larger than the depth d of the recess 33, the portion 2 is compressed by the lid surface 332 towards the bottom surface 331 of the recess 33. In this embodiment, the lid surface 332 is simply an extension of a surrounding flat surface of the second housing element 32, and is the part of the flat surface which is arranged to oppose the bottom surface of the recess 33 in the closed position.

The heater assembly 1 is arranged to supply heat to the substrate storage chamber 33 at surface 331, in order to heat the aerosol generating substrate and generate the aerosol. In other words, the support surface of the base 11 is arranged to correspond to the surface 331, facing into the substrate storage chamber 33. Preferably, the heating element 12 extends substantially across the whole of the surface 331, in order to increase the surface area for delivering heat to the aerosol generating substrate 2.

Compression between the surfaces 331 and 332, in combination with the heater 1 of the invention, means that the compression causes the moulding surface of the heater 1 to deform the portion 2 of aerosol generating substrate according to the moulding surface of the heating element 11. Because the pressure causes the heating element 1 to deform the portion 2, the heating element 11 conforms to a larger surface area of the aerosol generating substrate 2. Additionally, the compression of certain parts of the aerosol generating substrate according to the moulding surface improves the efficiency of heating the aerosol generating substrate.

However, compressing the aerosol generating substrate also reduces the spare volume in the aerosol generating substrate in which vapour/aerosol can form. A porous base 11 can compensate for this by providing additional porous volume in which the vapour/aerosol can form.

The portion 2 of aerosol generating substrate may optionally also comprise a pressure-activated heat generating element such as a capsule of ingredients for an exothermic reaction.

The device 3 also comprises an air flow channel 35 through the substrate storage chamber 33, which is provided in order to extract the generated aerosol from the substrate storage chamber 33. In the embodiment of FIGS. 4A to 4C, the air flow channel 35 comprises an inlet 351 connected between the exterior of the device 3 and one end of the substrate storage chamber 33, and an outlet 352 connected between the exterior of the device 3 and another end of the substrate storage chamber 33. The exterior of the device 3 around the outlet 352 is configured as a mouthpiece so that a user can inhale air and aerosol through the device 3. Alternatively, air may be artificially pumped through the air flow channel 35, for example using a fan.

In the embodiment shown in FIGS. 4A to 4C, the first and second housing members 31 and 32 are connected by one or more fasteners 36, which are hinges in this case, along a pivot line that is approximately aligned with a length direction between the inlet 351 and the outlet 352. By rotating on the hinges 36, the first and second housing elements 31, 32 move between an open position (shown in FIG. 4A) and a closed position (shown in FIGS. 4B and 4C). In the open position, the recess 331 is exposed, and the portion 2 of aerosol generating substrate can be added or removed, and the device 3 (and in particular the heater assembly 1) can be cleaned. In the closed position, the substrate storage chamber is completed and the aerosol can be generated. In other embodiments, the first and second housing members 31 and 32 may be fully separated in the open position, and may be connected together in the closed position by, for example, one or more releasable fasteners such as magnets or snap-fit connectors.

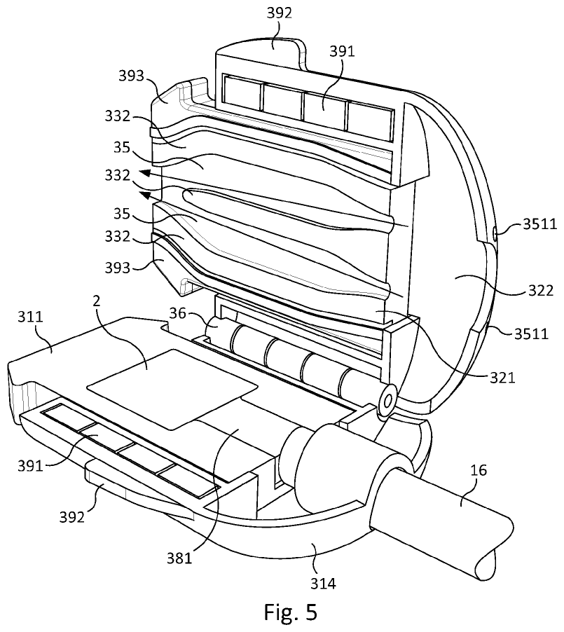

FIG. 5 is a perspective view of a first specific example of an aerosol generating device 3 in the open position, corresponding to the more general device illustrated in FIG. 4.

In this example, each of the first and second housing elements 31, 32 comprises an inner portion 311, 321 and an outer portion 314, 322. The outer portions 314, 322 provide an outer casing which is configured to be handheld. For example, the outer portions 314, 322 may comprise a rigid metal casing supporting weaker inner portions 311, 321. Additionally or alternatively, the outer portions 314, 322 may have lower thermal conductivity than the inner portions, in order to protect a user's hand, for example by providing an elastomer grip on an outer surface of the device.

Additionally, in the first specific example, the air flow channel 35 comprises a plurality of distinct inlets 3511 (two in this case) in one end of the outer portion 322 of the second housing element 32, to provide the inlet 351. Air then flows into two channels extending in parallel, the channels being formed as grooves on a surface of the inner portion 321 of the second housing element 32 connected between the inlet and the outlet. The grooves are surrounded by and separated by portions of the compression surface 332, with the effect of providing regions of improved aerosol generation adjacent to regions of improved airflow in the portion 2 of aerosol generating substrate.

The grooves provide a channel of varying width between the inlets and the outlet, with small inlets and a comparatively large outlet. When air is drawn through the device 3 in the closed position, this configuration creates a pressure gradient in the air flow channel 35 and reduces the air pressure adjacent to the portion 2 of aerosol generating substrate, further increasing aerosol generation.

Additionally, in the first specific example, the heater assembly (not shown in FIG. 5 but configured similarly to FIGS. 4B and 4C at the flat bottom surface of the recess 331) is driven by an external power source connected by electrical wire 16. The device 1 can be manufactured for use with an external power source, by cutting or moulding space for the electrical wire 16 in the inner portion 311 of the first housing element 31, and then providing a glue fill section 381 to separate the air flow channel 35 from the electrical wire 16. Alternatively section 381 could be an additional solid component that is fitted in place, such as a snap-fit or press-fit component. In some embodiments, the electrical wire 16 connecting to an external power source can be replaced with an internal power source. With an internal power source, the aerosol generating device can be provided as a portable handheld device.

Furthermore, in the first specific example, the device 3 comprises several closing means 391, 392 and 393 for improving the closure of the device 3 in the closed position and thereby making the device 3 easier to operate with good aerosol generation.

Firstly, the first and second housing elements 31, 32 are held in place in the closed position using one or more releasable fasteners (e.g. pairs of opposing magnets 391) opposed to the hinge 36. Providing releasable fasteners means that the device 3 need not be held in the closed position by hand throughout aerosol generation, making the device easier to use.

Secondly, tab surfaces 392 are provided which can be manually operated by a user's hand to open and close the device 3 between the open and closed positions. Providing the tab surfaces 392 means that the strength of the releasable fasteners can be increased without making it difficult for a user to move the device 3 from the closed position to the open position.

Thirdly, a gasket 393 is provided which, in the closed position, improves sealing of the air flow channel 35 between the inlet(s) and the outlet. The gasket may, for example, be formed from an elastomer such as rubber.

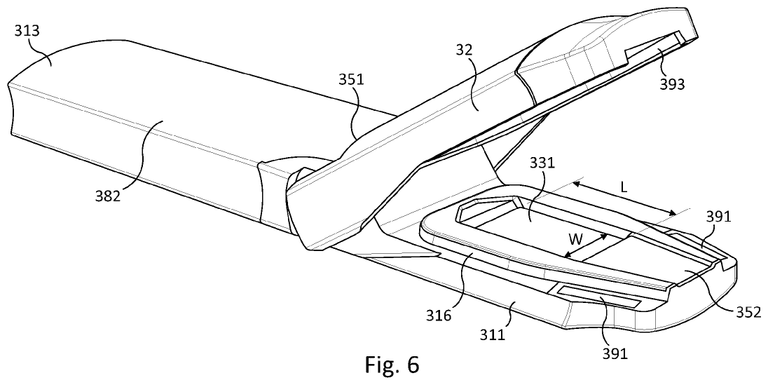

FIG. 6 is a schematic illustration of a second specific example of the aerosol generating device in an open position.

In the second specific example, first and second housing elements 31, 32 are connected by a pivot line that is perpendicular to a length direction between an inlet 351 and an outlet 352. In this case, the inlet may be a gap between the first and second housing elements 31, 32 along the pivot line.

Additionally, in order to improve a seal provided by gasket 393, the gasket is arranged to engage with an outer recess wall 316 of the first housing element 31 extending around the recess 33 and the heater assembly 1.

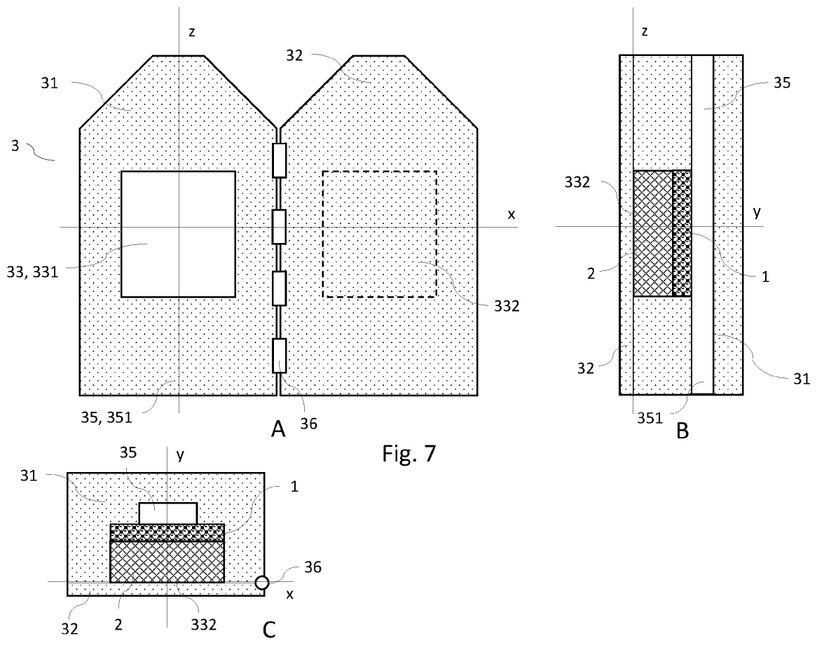

Furthermore, as shown in FIG. 6, in some embodiments, the electrical wire 16 connecting to an external power source can be replaced with an internal power source 382. With an internal power source, the aerosol generating device 3 can be provided as a portable handheld device. In the example of FIG. 7, the internal power source 382 is provided in an extended inlet portion 313 of the device 3, although other arrangements of the internal power source would be apparent to the skilled person.

FIGS. 7A, 7B and 7C are schematic cross-sections of an alternative example of an aerosol generating device 3 incorporating a heater 1 as described above with reference to FIG. 2A or 3, with lines x, y and z showing the relative planes of the cross-sections.

The alternative example is largely similar to the example described above with reference to FIGS. 4A, 4B and 4C, and only the differences are described here.

In the alternative example, the heater 1 is arranged between the substrate storage chamber 33 and the air flow channel 35, as shown in FIGS. 7B and 7C.

As mentioned above, the base 11 of the heater 1 in some embodiments incorporates a porous material such as a porous ceramic. As such, vapour and/or aerosol can travel through the porous structure of the base 11 to the air flow channel 35.

As an addition or alternative to the porous structure of the bulk material of the base, the base 11 may comprise one or more specifically constructed ducts through which vapour and/or aerosol may travel from the substrate storage chamber 33 to the air flow channel 35.

As air is drawn along the air flow channel 35, the pressure in the air flow channel 35 may be reduced adjacent to the base 11, further drawing vapour and/or aerosol into the air flow channel 35, through the porous structure or ducts.

In order to accommodate this rearrangement of the heater 1, the first housing element 31 and a second housing element 32 may be configured to divide the device 3 in a plane which does not include the air flow channel 35, contrary to the first example of FIGS. 4A to 4C.

Specifically, the plane of the open aerosol generating device 3 shown in FIG. 7A corresponds to the lines x and z illustrated in FIGS. 7B and 7C, and this plane is separated from the air flow channel 35, meaning that the air flow channel 35 is now fully enclosed within the first housing element 31.

As an alternative for the example of FIGS. 7A to 7C, the first housing element 31 and a second housing element 32 may be configured to separate in a plane between the heater assembly 1 and the substrate storage chamber 33, such that the heater assembly 1 is part of the first housing element 31 and the internal space of the substrate storage chamber 33 is a recess in the second housing element 32.

1. A heater for heating a consumable comprising a solid aerosol generating substrate, the heater comprising:
a base; and
a heating element attached to a support surface of the base,
wherein the heating element comprises a moulding surface configured to deform and heat the aerosol generating substrate, and
wherein the heating element comprises a conductive track extending along and protruding from the support surface.

2. The heater according to claim 1, further comprising an extension protruding from the base to form a moulding shape or blade shape, wherein the conductive track is on the extension.

3. The heater according to claim 2, wherein the extension is monolithic with the base.

4. The heater according to claim 1, wherein the conductive track has a serpentine configuration.

5. The heater according to claim 1, wherein the heating element protrudes from the support surface by a protrusion distance of at least 0.5 mm.

6. The heater according to claim 1, wherein the base comprises a porous ceramic material, and at least part of the support surface is exposed to receive a vapour or aerosol generated from the aerosol generating substrate.

7. An aerosol generation device comprising a substrate storage chamber configured to receive a consumable comprising a solid aerosol generating substrate, the substrate storage chamber comprising the heater according to claim 1 arranged on a surface of the substrate storage chamber with the support surface facing into the substrate storage chamber.

8. The aerosol generation device according to claim 7, further comprising an air flow channel for drawing air through the aerosol generation device, wherein the heater is arranged between the substrate storage chamber and the air flow channel.

9. The aerosol generation device according to claim 7, wherein the heating element extends substantially across the whole of the surface of the substrate storage chamber.

10. The aerosol generation device according to claim 7, further comprising a compression element configured to compress the consumable against the heater.

11. An aerosol generation system comprising the heater according to claim 1 and a consumable comprising a solid aerosol generating substrate, wherein the heating element protrudes from the support surface of the base by at least 5% of a thickness of the consumable.
